(19) United States
(12) Patent Application Publication
(10) Pub. No.: US 2020/0338826 A1
(43) Pub. Date: Oct. 29, 2020

(54) 3D PRINTER AND PRINTING SYSTEM

(71) Applicant: RYUJIN LAB, INC., Seongnam-si, Gyeonggi-do (KR)

(72) Inventors: Seong Jin PARK, Seogwipo-si (KR); Hong Joo LEE, Seoul (KR); Kihyung KIM, Jeungpyeong-gun (KR)

(73) Assignee: RYUJIN LAB, INC., Seongnam-si, Gyeonggi-do (KR)

(21) Appl. No.: 16/955,907

(22) PCT Filed: Dec. 3, 2018
(86) PCT No.: PCT/KR2018/015170

§ 371 Date: Jun. 19, 2020

(30) Foreign Application Priority Data
Dec. 22, 2017 (KR) 10-2017-0178491
Dec. 3, 2018 (KR) 10-2018-0153316

(51) Int. Cl. B29C 64/264; B29C 64/393; B29C 64/129; B33Y 30/00; B33Y 50/02

(52) U.S. Cl. CPC B29C 64/264; B29C 64/393; B33Y 50/02; B33Y 30/00; B29C 64/129

(57) ABSTRACT

Proposed herein are a three-dimensional (3D) printer and a printing system. The 3D printer includes: an accommodation part formed in a box shape having an open top, and configured to accommodate a photocurable resin therein; a light transmission member configured to transmit light into the accommodation part while forming the bottom of the accommodation part; a self-light emission member disposed beneath the light transmission member, and configured to radiate light in a 2D planar shape; a support member disposed beneath the self-light emission member, and configured to prevent the self-light emission member from sagging downward; a plate disposed above the accommodation part to be selectively lifted and lowered, and configured to be immersed in the photocurable resin and to allow the photocurable resin to be stacked on the bottom surface thereof; and a lifting/lowering member configured to selectively lift and lower the plate.

### TECHNICAL FIELD

Embodiments disclosed herein relate to three-dimensional (3D) printers, and more particularly to photocurable 3D printers using a planar self-light emission source, which are capable of performing 3D printing by curing a photocurable resin using a self-light emission device, including a micro-light emitting diode (LED), an LED, an organic light emitting diode (OLED), and a field emission display (FED), through the expansion of the method of a planar light source.

### BACKGROUND ART

In general, a 3D printer (a 3D manufacturing device) is a technology that implements an actually manufactured object by structuring (slicing) an object into very thin layers using the 3D information of the object composed of a digital file and then piling up materials on a per-layer basis based on the information.

Such 3D printers are basically classified into the following technologies:

FDM (FFF) method: This stands for a fused deposition modeling (or fused filament fabrication) method. More specifically, the FDM method heats a synthetic resin such as ABS, PLA or the like to a high temperature of about 200 degrees to convert it into a molten gel state, and then pushes it through an ejector to quickly solidify as the gel resin is deposited on a substrate at room temperature. A desired manufactured object is obtained by stacking solidified layers on a per-layer basis.

Photocuring stacking method: This method uses as a material a photocurable resin that is solidified when it receives light having a specific wavelength, for example, ultraviolet rays. When ultraviolet rays are radiated onto a manufacture target area using an ultraviolet laser (stereolithographic annealing (SLA)) or UV lamp (digital light processing (DLP)) through a container accommodating a resin, a portion having received the rays are solidified, and the solidified portion is vertically lifted out. A precisely stacked manufactured object can be obtained by repeating ‘light radiation-solidification’ on a per-layer basis.

In addition, there are a PolyJet method that obtains a desired manufactured object by selectively spraying an (photocurable) adhesive resin onto a powdered material and a selective laser solidification (SLS) method that implements a manufactured object through instant melting-sintering by selectively radiating high-power laser light to the powder of metal, ceramics or the like.

Among these methods, the DLP method that sequentially forms layers by radiating light such as ultraviolet rays onto a photocurable resin is a technology that expands a projection target image into a ‘plane’ by using a projector equipped with an optical system when manufacturing an object and then projects the plane, and is also called a mask projection image curing method.

This DLP method includes a material supply device called a water tank and a projector configured to cure a material into a desired shape on a per-layer basis, and also includes an actuator configured to move a cured object to a subsequent layer and a plate connected to the actuator. The DLP method expands and then projects a small image by using the optical system, and thus the size of a 3D printer using the DLP method becomes large in order to output a large-area manufactured object, with the result that the size of an output product is limited. Furthermore, the configuration of the optical system is complicated, and thus a disadvantage arises in that the price of the 3D printer is very high. In addition, the DLP method is a method that expands a modeling image. When an expanded, projected image is implemented, there occurs a problem with optical uniformity, and thus a shortcoming arises in that it is difficult to form the periphery of the water tank.

In order to mitigate the disadvantages of the above-described methods, there was developed a method using an LCD and an LED, i.e., a planar light source, as a method configured to ensure optical uniformity by allowing light to correspond to a stacking target location in a one-to-one correspondence and to allow a plurality of layers to be simultaneously stacked because a large, big manufacture target object could be constructed.

However, the above prior art has a limitation in that it is restricted to the LCD and the LED as planar light sources. In addition, when the LED light source is imaged through the LCD, the amount of LED light is absorbed while passing through the LCD structure, and thus manufacture time or exposure time is increased due to a decrease in the transmittance of the LED light, so that there is a limitation on rapidly manufacturing a manufacture target object (a 3D output product).

As a related prior art, there is a color 3D printer disclosed in Korean Patent No. 10-1787880.

The above prior art technology is configured such that the layers of a manufacture target object are stacked on a modeling plate by providing light from a location below a tank in which a photocurable material is accommodated.

This prior art has a problem in that the light source sags because there is no configuration for supporting the bottom of the light source, and there is a limitation in that a manufactured object is formed only on the bottom surface of the modeling plate.

Therefore, there is a demand for technology for overcoming the above-described problems.

Meanwhile, the above-described background technology corresponds to technical information that has been possessed by the present inventor in order to contrive the present invention or which has been acquired in the process of contriving the present invention, and can not necessarily be regarded as well-known technology which had been known to the public prior to the filing of the present invention.

### DISCLOSURE

### Technical Problem

An object of embodiments disclosed herein is to propose a 3D printer and printing system that may implement 3D printing by curing a photocurable resin using a self-light emission device beyond the level of the conventional technology configured to provide planar light.

More specifically, an object of embodiments disclosed herein is to propose a 3D printer and printing system that provide the light of a self-light emission device in a two-dimensional (2D) planar shape, thereby allowing the configuration of a separate switching device to be omitted, and prevent the self-light emission device from sagging.

Furthermore, an object of embodiments disclosed herein is to propose a 3D printer and printing system that allow a self-light emission device to be physically curved, thereby providing light in a condensed form.

Moreover, an object of embodiments disclosed herein is to propose a 3D printer and printing system that may provide light from a location above an accommodation part, thereby allowing the layers of a manufacture target object to be stacked on the top surface of a plate.

### Technical Solution

As a technical solution for achieving the above-described technical problem, there is provided one aspect of a 3D printer according to an embodiment, the 3D printer including: an accommodation part formed in a box shape having an open top, and configured to accommodate a photocurable resin therein; a light transmission member configured to transmit light, radiated from a location below the accommodation part, into the accommodation part while forming the bottom of the accommodation part; a self-light emission member disposed beneath the light transmission member, and configured to radiate light toward the accommodation part, that is to say, to radiate light in a 2D planar shape; a support member disposed beneath the self-light emission member, and configured to prevent the self-light emission member from sagging downward; a plate disposed above the accommodation part to be selectively lifted and lowered, and configured to be immersed in the photocurable resin and to allow the photocurable resin cured by the light of the self-light emission member to be stacked on a bottom surface thereof, thereby forming a 3D manufactured object; and a lifting/lowering member configured to selectively lift and lower the plate.

Furthermore, as a technical solution for achieving the above-described technical problem, there is provided another aspect of a 3D printer according to an embodiment, the 3D printer including: an accommodation part formed in a box shape having an open top, and configured to accommodate a photocurable resin therein; a self-light emission member disposed in the upper portion of the accommodation part, and configured to radiate light toward the accommodation part, that is to say, to radiate light in a 2D planar shape; a plate disposed in the accommodation part to be selectively lifted and lowered, and configured to be immersed in the photocurable resin and to allow the photocurable resin cured by the light of the self-light emission member to be stacked on the top surface thereof, thereby forming a 3D manufactured object; and a lifting/lowering member configured to selectively lift and lower the plate.

Moreover, as a technical solution for achieving the above-described technical problem, there is provided one aspect of a printing system according to an embodiment, the printing system including: an image processor configured to analyze a 3D drawing of a manufacture target object into transverse cross-sectional images for respective heights and then sequentially transmit the analyzed individual transverse cross-sectional images to the 3D printer; wherein a 3D printer includes a controller configured to control the self-light emission member so that light having a two-dimensional planar shape corresponding to each of the cross-sectional images is radiated.

### Advantageous Effects

According to any one of the above-described solutions, there may be proposed the 3D printer and printing system in which the self-light emission member provides light in a 2D planar shape via a self-light emission device, thereby allowing the configuration of a separate switching device to be omitted, and in which light is provided without a reduction in optical efficiency, thereby allowing the photocurable resin to be uniformly cured.

According to any one of the above-described solutions, there may be proposed the 3D printer and printing system that, when a micro-lens is additionally disposed on the self-light emission member, may provide the light of a self-light emission member in various shapes and to various depths because the light of the self-light emission member is condensed, dispersed or radiated in parallel.

Furthermore, according to any one of the above-described solutions, there may be proposed the 3D printer and printing system in which the self-light emission member may be physically curved by the curving member, thereby allowing the light of the self-light emission member radiated into the accommodation part to be condensed to the center portion of the accommodation part or to be dispersed to the outside of the accommodation part.

Moreover, according to any one of the above-described solutions, there may be proposed the 3D printer and printing system that, when the self-light emission member is disposed in the upper portion of the accommodation part so that it allows the layers of a manufacture target object to be stacked on the top surface of the plate while radiating light downward, allow the configuration of the support member and the configuration of the light transmission member to be omitted because the load of the accommodation part is not applied to the self-light emission member.

The effects that can be obtained by embodiments disclosed herein are not limited to the above-described effects, and other effects that have not been described above will be apparently understood by those having ordinary skill in the art, to which the present invention pertains, from the following description.

### DESCRIPTION OF DRAWINGS

FIG. 1 is a diagram showing the configuration of a 3D printer according to a first embodiment;

FIG. 2 is a diagram showing the configuration of a state in which an additional configuration is added to the 3D printer according to the first embodiment;

FIG. 3 is a diagram showing the configuration of a 3D printer according to a second embodiment;

FIG. 4 is a diagram showing the configuration of a state in which an additional configuration is added to the 3D printer according to the second embodiment; and

FIG. 5 is a block diagram showing a printing system according to an embodiment.

### MODE FOR INVENTION

Embodiments of the present invention will be described in detail below with reference to the accompanying drawings so that those having ordinary skill in the art to which the present invention pertains can easily practice the present invention. However, the present invention may be implemented in various different forms, and is not limited to the embodiments described herein. Furthermore, portions unrelated to the present invention are omitted in the drawings in order to more clearly illustrate the present invention. Throughout the specification, like reference symbols will be assigned to like portions.

Throughout the specification, when one portion is described as being “connected” to another portion, this includes not only a case where they are “directly connected” to each other but also a case where they are “indirectly connected” to each other with another component disposed therebetween. Furthermore, when any portion is described as including any component, this does not mean that the portion does not exclude another component but means that the portion may further include another component, unless explicitly described to the contrary.

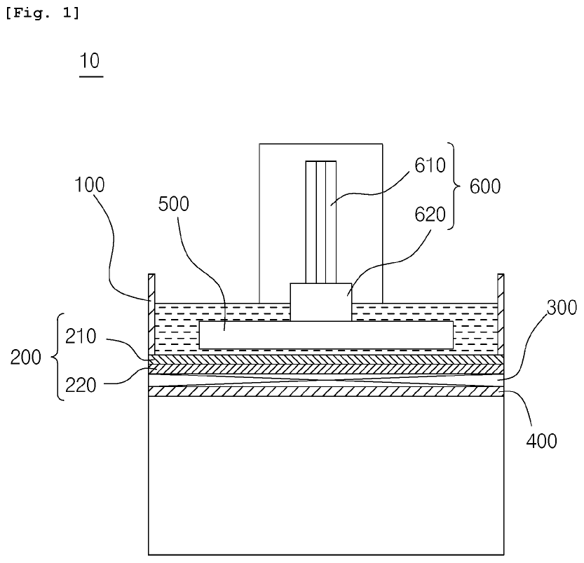

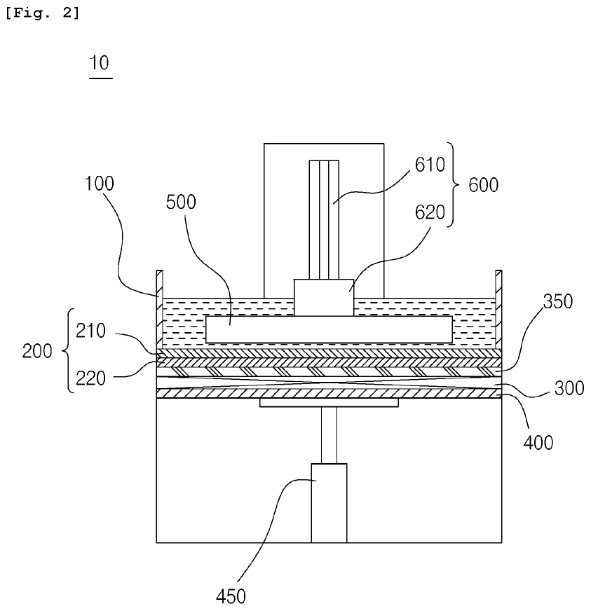

FIG. 1 is a diagram showing the configuration of a 3D printer according to a first embodiment, and FIG. 2 is a diagram showing the configuration of a state in which an additional configuration is added to the 3D printer according to the first embodiment.

Referring to FIG. 1, the 3D printer 10 according to the first embodiment may be configured to include an accommodation part 100, a light transmission member 200, a self-light emission member 300, a support member 400, a plate 500, and a lifting/lowering member 600.

The accommodation part 100 may be formed in a box shape having an open top, and may accommodate a photocurable resin that is curable by light.

In this case, the photocurable resin is cured when it receives light such as ultraviolet rays, and any configuration known in the field to which the present invention pertains may be applied.

The light transmission member 200 is a component that transmits light, radiated through the self-light emission member 300 to be described later from a location below the accommodation part 100, into the accommodation part 100 while forming the bottom of the accommodation part 100.

For example, the light transmission member 200 may be composed of a heterogeneous film, and may be configured to include an upper film 210 configured to face the plate 500 to be described later while forming the upper part of the heterogeneous film and a lower film 220 configured to come into close contact with the self-light emission member 300 to be described later while forming the lower part of the heterogeneous film.

In this case, the upper film 210 may be composed of a fluorine resin-type film or a Teflon film, and the lower film 220 may be composed of a PET film.

The self-light emission member 300 is a component that is disposed beneath the light transmission member 200 and radiates light toward the accommodation part 100, that is to say, radiates light in a two-dimensional (2D) planar shape.

The self-light emission member 300 may be composed of any one or more of self-light emission display devices. More specifically, the self-light emission member 300 may be composed of a set of any one type of devices selected from the group of self-light emission display devices including, e.g., micro-light emitting diodes (LEDs), LEDs, organic light emitting diodes (OLEDs), and field emission displays (FEDs), and may additionally include devices that provide light having a predetermined wavelength. In other words, the self-light emission member 300 is configured such that self-light emission display devices form a panel having a predetermined area as a set, and can thus emit light in a planar shape.

The support member 400 is a component that is disposed beneath the self-light emission member 300 and prevents the self-light emission member 300 from sagging downward.

The support member 400 may be composed of a flat structure having rigidity so as to provide supporting force from the bottom of the self-light emission member 300, and may be made of an opaque material because there is no need to transmit the light of the self-light emission member 300.

Meanwhile, the support member 400 may include the configuration of a three-axis stage capable of selectively lifting and lowering the self-light emission member 300 while moving the self-light emission member 300 in a lateral or vertical direction in order to adjust the position of the self-light emission member 300 while supporting the self-light emission member 300.

The plate 500 is a component configured to form a 3D manufactured object, and may be disposed above the accommodation part 100 to be selectively lifted and lowered, be immersed in the photocurable resin while being lowered, and allow the photocurable resin cured by the light of the above-described self-light emission member 300 to be stacked on the bottom surface thereof, thereby forming a 3D manufactured object.

More specifically, the plate 500 is lowered by the lifting/lowering member 600 to be described later and made to face the above-described light transmission member 200. In this state, when the light of the self-light emission member 300 is radiated, part of the photocurable resin corresponding to the planar shape of the radiated light is cured and stacked on the bottom surface of the plate 500. The plate 500 may be lifted by the lifting/lowering member 600 again.

The lifting/lowering member 600 is a component that selectively lifts and lowers the plate 500 to and from a location above the accommodation part 100.

The lifting/lowering member 600 may be configured to include a lifting/lowering rail 610 and a slider 620.

The lifting/lowering rail 610 is disposed adjacent to the accommodation part 100 and extends in a vertical direction, thereby providing a lifting/lowering path for the plate 500.

The slider 620 is movably coupled to the lifting/lowering rail 610 in the state of being fastened to the plate 500, and may selectively lift and lower the plate 500 while moving along the lifting/lowering rail 610 under control.

In this case, the slider 620 and the lifting/lowering rail 610 may be constructed using a ball screw method, a linear motor method, or a rack and pinion gear method, and may selectively lift and lower the plate 500 while moving linearly.

Furthermore, the lifting/lowering member 600 may be provided with a horizontal movement member (not shown) that horizontally moves the slider 620 in order to correct the location of the plate 500.

Meanwhile, referring to FIG. 2, a micro-lens 350 may be disposed over the above-described self-light emission member 300.

The micro-lens 350 is intended to improve the intensity or precision of the light of the self-light emission member 300, is disposed over the self-light emission member 300, and condenses or disperses the light emitted from the self-light emission member 300 or radiates the light in parallel.

More specifically, the micro-lens 350 may be formed in various shapes, such as a convex shape, a concave shape, a planar shape, a spherical shape, and a polygonal shape, and may condense or disperse light or radiate light in parallel according to its shape and provide it into the accommodation part 100.

Furthermore, the above-described support member 400 may be configured to be curved by the pressing of external force. For example, the support member 400 may be formed to have a thickness or material that allows the center portion thereof to be curved by gravity.

The support member 400 may be curved along with the above-described self-light emission member 300 while being curved upward or downward by the pressing of the curving member 450.

More specifically, the curving member 450 may be composed of a hydraulic cylinder configured to support the lower end of the center portion of the support member 400, and may curve the support member 400 and the self-light emission member 300 upward or downward by lifting a support portion through upward pressing or by lowering a support portion.

In this case, light may be condensed when the center portion of the self-light emission member 300 is curved downward, and light may be dispersed when the center portion of the self-light emission member 300 is curved upward.

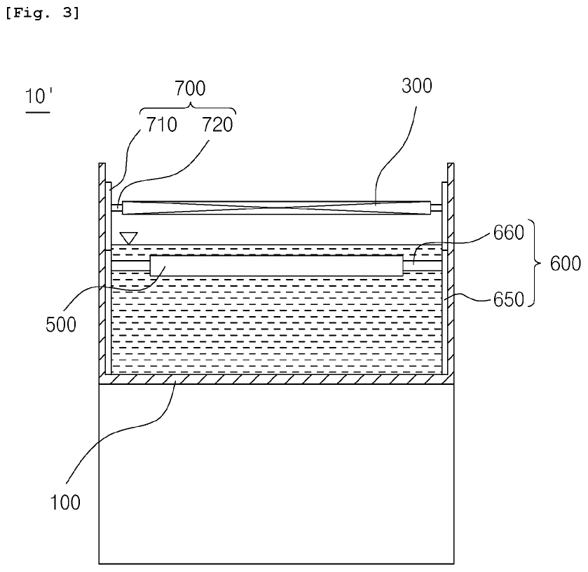

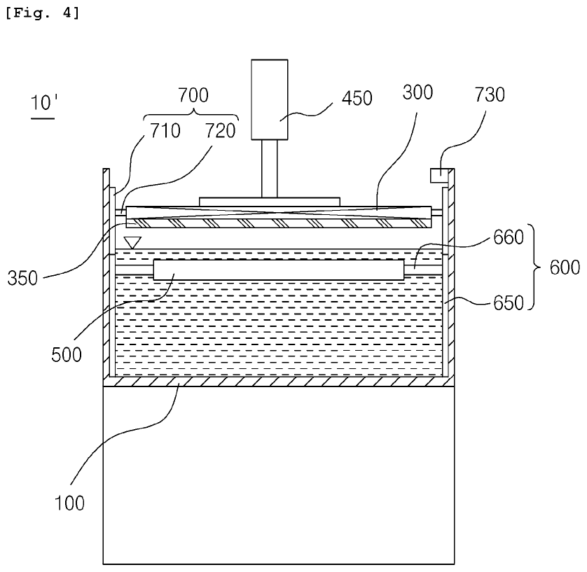

Meanwhile, FIG. 3 is a diagram showing the configuration of a 3D printer according to a second embodiment, and FIG. 4 is a diagram showing the configuration of a state in which an additional configuration is added to the 3D printer according to the second embodiment.

Referring to FIG. 3, a 3D printer 10′ according to the second embodiment is configured such that as light is radiated from a location above the accommodation part 100, a photocurable resin is stacked on the top surface of a plate 500, unlike the 3D printer 10 according to the first embodiment.

More specifically, the 3D printer 10′ according to the second embodiment may be configured to include an accommodation part 100, a self-light emission member 300, a plate 500, and a lifting/lowering member 600, and the configurations of the above-described light transmission member 200 and support member 400 may be omitted.

The accommodation part 100 may be formed in the form of a box having an open top, the bottom surface thereof may be made of the same material, and the accommodation part 100 may accommodate a curable resin.

The self-light emission member 300 may have the same configuration as that of the above-described first embodiment, may be disposed in the upper portion of the accommodation part 100, and may radiate light into the lower portion of the accommodation part 100 in a planar shape.

The plate 500 may be disposed in the accommodation part 100 to be selectively lifted and lowered by the lifting/lowering member 600 to be described later, may be immersed in the photocurable resin, and may form a 3D manufactured object by allowing the photocurable resin, cured by the light of the self-light emission member 300, to be stacked on the top surface thereof.

More specifically, the plate 500 may be lifted by the lifting/lowering member 600 to be described later in the state of being immersed in the photocurable resin in the accommodation part 100, and may be made to face the self-light emission member 300. In this state, when the light of the self-light emission member 300 is radiated, the photocurable resin corresponding to the planar shape of the radiated light may be stacked on the top surface of the plate 500. The plate 500 may be lowered by the lifting/lowering member 600 again.

The lifting/lowering member 600 may be a component configured to selectively lift and lower the plate 500, and may be configured to include plate lifting/lowering rails 650 and plate sliders 660.

The plate lifting/lowering rails 650 may be disposed on both side walls of the accommodation part 100, may extend in a vertical direction, and may provide a lifting/lowering path for the plate 500.

The plate sliders 660 may be movably coupled to the plate lifting/lowering rails 650 in the state of being fastened to both sides of the plate 500, and may selectively lift and lower the plate 500 while moving along the plate lifting/lowering rails 650 under control.

In this case, the plate sliders 660 and the plate lifting/lowering rails 650 may be constructed using a ball screw method, a linear motor method, or a rack and pinion gear method, and may selectively lift and lower the plate 500 while moving linearly.

Meanwhile, referring to FIG. 4, the above-described micro-lens 350 may be disposed beneath the self-light emission member 300 and condense or disperse light or radiate light in parallel, and the above-described curving member 450 may be disposed over the self-light emission member 300 and curve the self-light emission member 300 upward or downward.

In this case, since the micro-lens 350 and the curving member 450 have the same configurations as those of the first embodiment, detailed descriptions thereof will be omitted.

Meanwhile, the 3D printer 10′ according to the second embodiment may be configured to include a light source lifting/lowering member 700.

The light source lifting/lowering member 700 is a component that selectively lifts and lowers the self-light emission member 300 depending on the level of the photocurable resin while liftably coupling the self-light emission member 300 to the accommodation part 100, thereby keeping the distance between the self-light emission member 300 and the stacking surface of the plate 500 uniform.

In other words, the light source lifting/lowering member 700 may lower the self-light emission member 300 when the level of the photocurable resin falls, and may lift the self-light emission member 300 when the level of the photocurable resin rises, thereby allowing the light of the self-light emission member 300 to be radiated onto the top surface of the photocurable resin at uniform intensity.

More specifically, the light source lifting/lowering member 700 may be configured to include light source lifting/lowering rails 710 and light source sliders 720.

The light source lifting/lowering rails 710 may be disposed on both side walls of the accommodation part 100, may extend in a vertical direction, and may provide a lifting/lowering path for the self-light emission member 300.

These light source lifting/lowering rails 710 may be formed by extending from the above-described plate lifting/lowering rails 650.

The light source sliders 720 may be movably coupled to the light source lifting/lowering rails 710 in the state of being fastened to both sides of the self-light emission member 300, and may selectively lift and lower the self-light emission member 300 while moving along the light source lifting/lowering rails 710 under control.

In this case, the light source sliders 720 and the light source lifting/lowering rails 710 may be constructed using a ball screw method, a linear motor method, or a rack and pinion gear method, and may selectively lift and lower the self-light emission member 300 while moving linearly.

Meanwhile, a resin level sensor 730 configured to detect the level of the photocurable resin may be disposed in the accommodation part 100 such that the light source sliders 720 may be selectively lifted and lowered in response to a level detection signal for the photocurable resin.

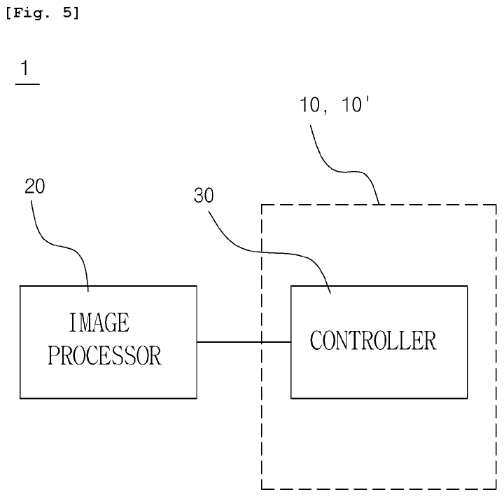

The 3D printer 10 or 10′ including the above-described components may be applied to a printing system 1 including an image processor 20, as shown in FIG. 5, and may perform printing under the control of a 3D controller 30.

More specifically, the image processor 20 may analyze a 3D drawing of a manufacture target object into transverse cross-sectional images for respective heights, and may then sequentially transmit the analyzed multiple transverse cross-sectional images to the 3D printer 10 or 10.′

In this case, the multiple transverse cross-sectional images may be transmitted to the 3D printer 10 according to the first embodiment in a sequence from the cross-sectional image of the top end of the manufacture target object, and may be transmitted to the 3D printer 10′ according to the second embodiment in a sequence from the cross-sectional image of the bottom end of the manufacture target object.

Furthermore, the controller 30 may control the self-light emission member 300 so that light having a 2D planar shape corresponding to each of the cross-sectional images is radiated into the accommodation part 100, thereby stacking the photocurable resin on the bottom or top surface of the plate 500.

As described above, in accordance with the 3D printer 10 or 10′ and the printing system 1 according to the embodiment, the configuration of a separate switching device may be omitted because the self-light emission member 300 provides light in a 2D planar shape via the self-light emission device, and the photocurable resin may be uniformly cured because light may be provided without a reduction in optical efficiency.

The above-described embodiments are intended for illustrative purposes. It will be understood that those having ordinary skill in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the above-described detailed description. All modifications and variations that can be derived from the meanings, scopes and equivalents of the claims should be construed as falling within the scope of the present invention.

1. A three-dimensional (3D) printer comprising:
an accommodation part formed in a box shape having an open top, and configured to accommodate a photocurable resin therein;
a light transmission member configured to transmit light, radiated from a location below the accommodation part, into the accommodation part while forming a bottom of the accommodation part;
a self-light emission member disposed beneath the light transmission member, and configured to radiate light toward the accommodation part, that is to say, to radiate light in a two-dimensional (2D) planar shape;
a support member disposed beneath the self-light emission member, and configured to prevent the self-light emission member from sagging downward;
a plate disposed above the accommodation part to be selectively lifted and lowered, and configured to be immersed in the photocurable resin and to allow the photocurable resin cured by the light of the self-light emission member to be stacked on a bottom surface thereof, thereby forming a 3D manufactured object; and
a lifting/lowering member configured to selectively lift and lower the plate.

2. The 3D printer of claim 1, wherein the self-light emission member comprises a set of any one type of devices selected from the group of self-light emission display devices including micro-light emitting diodes (LEDs), LEDs, organic light emitting diodes (OLEDs), and field emission displays (FEDs), and emits light in a planar shape.

3. The 3D printer of claim 1, wherein the light transmission member comprises:
an upper film configured to face the plate; and
a lower film provided beneath the upper film, integrated with the upper film, and configured to come into close contact with the self-light emission member.

4. The 3D printer of claim 1, further comprising a micro-lens disposed over the self-light emission member and configured to condense or disperse the light radiated from the self-light emission member or radiate the light in parallel.

5. The 3D printer of claim 1, wherein:
the support member is configured to be curved by pressing of external force; and
the 3D printer further comprises a curving member configured to curve the support member and the self-light emission member by lifting or lowering a support portion while supporting a lower end of a center portion of the support member.

6. A three-dimensional (3D) printer comprising:
an accommodation part formed in a box shape having an open top, and configured to accommodate a photocurable resin therein;
a self-light emission member disposed in an upper portion of the accommodation part, and configured to radiate light toward the accommodation part, that is to say, to radiate light in a two-dimensional (2D) planar shape;
a plate disposed in the accommodation part to be selectively lifted and lowered, and configured to be immersed in the photocurable resin and to allow the photocurable resin cured by the light of the self-light emission member to be stacked on a top surface thereof, thereby forming a 3D manufactured object; and
a lifting/lowering member configured to selectively lift and lower the plate.

7. The 3D printer of claim 6, wherein the self-light emission member comprises a set of any one type of devices selected from the group of self-light emission display devices including micro-light emitting diodes (LEDs), LEDs, organic light emitting diodes (OLEDs), and field emission displays (FEDs), and emits light in a planar shape.

8. The 3D printer of claim 6, further comprising a micro-lens disposed beneath the self-light emission member and configured to condense or disperse the light radiated from the self-light emission member or radiate the light in parallel.

9. The 3D printer of claim 6, wherein the lifting/lowering member comprises:
plate lifting/lowering rails disposed on both side walls of the accommodation part in a vertical direction; and
plate sliders provided on both sides of the plate, respectively, movably coupled to the plate lifting/lowering rails, and configured to selectively lift and lower the plate while moving along the plate lifting/lowering rails.

10. The 3D printer of claim 6, further comprising a light source lifting/lowering member configured to selectively lift and lower the self-light emission member depending on a level of the photocurable resin while liftably coupling the self-light emission member to the accommodation part.

11. The 3D printer of claim 10, wherein the light source lifting/lowering member comprises:
light source lifting/lowering rails disposed on both side walls of the accommodation part in a vertical direction; and
light source sliders provided on both sides of the self-light emission member, respectively, movably coupled to the light source lifting/lowering rails, and configured to selectively lift and lower the self-light emission member while moving along the light source lifting/lowering rails.

12. The 3D printer of claim 6, further comprising a curving member configured to curve the self-light emission member by lifting or lowering a support portion while supporting an upper end of a center portion of the support member.

13. A printing system comprising the three-dimensional (3D) printer of claim 1, the printing system comprising:
an image processor configured to analyze a 3D drawing of a manufacture target object into transverse cross-sectional images for respective heights and then sequentially transmit the analyzed individual transverse cross-sectional images to the 3D printer;
wherein the 3D printer comprises a controller configured to control the self-light emission member so that light having a two-dimensional planar shape corresponding to each of the cross-sectional images is radiated.
